(19) United States
(12) Patent Application Publication
(10) Pub. No.: US 2004/0016332 A1
(43) Pub. Date: Jan. 29, 2004

(54) Mat board cutter

(76) Inventors: Thomas David Price, Woodbury, MN (US); James F. Stewart, Shoreview, MN (US); David L. Heinz, Eagan, MN (US); William C. Tigner, Apple Valley, MN (US)

Correspondence Address: MERCHANT & GOULD PC, P.O. BOX 2903, MINNEAPOLIS, MN, 55402-0903, US

(21) Appl. No.: 10/206,811

(22) Filed: Jul. 26, 2002

(51) Int. Cl. B26D 7/02; B26D 7/01; B26D 5/08

(52) U.S. Cl. 83/455; 83/468; 83/581

(57) ABSTRACT

A blade holder for a mat board cutting machine, the blade holder including an open sided recess for receiving a blade, a screw for adjusting the extension of the blade from the recess and a magnet for releasably holding the blade within the recess. A cutter head for use with a mat board cutting machine, the cutter head including a blade carrier pivotably mounted to the cutter head for holding a blade holder. The blade holder includes an open sided recess for receiving a blade, a screw for adjusting the extension of the blade from the recess and a magnet for releasably holding the blade within the recess. A mat board cutting machine including a clamp for holding mat boards against a deck and a cutter head mounted to the clamp for cutting the mat board. The clamp is held between clamp hinges which include screws to exert a compressive force against the end of the clamp.

### FIELD OF THE INVENTION

The present invention relates generally to a mat board cutting device. More specifically, the present invention relates to improved blade and mat board holding capabilities for a mat board cutting device.

### BACKGROUND OF THE INVENTION

Mat boards are typically made of heavier paper stock and are used in framing artwork and other items. It is desirable to have the ability to cut these mat boards with a high degree of linearity, as even small deviations is the direction of the cut lines may be quite obvious when framed. Mat board cutting devices have been developed which aid the process of cutting mat boards to a desired size and shape for framing. Improvements to these devices are desirable.

Due to the heavy paper stock used to make mat boards, the cutting machines need to securely hold a cutting blade, allow for variable extension of the blade as needed to cut mat boards of different thickness, and permit the rapid and easy replacement of the blade, which wears quickly. To smoothly cut mat boards, the mat boards need to be securely held or clamped. Any movement of the mat board while a cut is being made may cause an undesirable and very noticeable variation in the cut edge, often requiring the mat board to be discarded.

Improvements to the blade holders and mat board clamps are desirable.

### SUMMARY OF THE INVENTION

The present invention relates to a blade holder for a mat board cutting machine including an open sided recess for receiving a blade, a screw for adjusting the extension of the blade from the recess and a magnet for releasably holding the blade within the recess. The present invention further relates to a cutter head for use with a mat board cutting machine including a blade carrier pivotably mounted to the cutter head for holding a blade holder. The blade holder includes an open sided recess for receiving a blade, a screw for adjusting the extension of the blade from the recess and a magnet for releasably holding the blade within the recess. The present invention also relates to a mat board cutting machine including a clamp for holding mat boards against a deck and a cutter head mounted to the clamp for cutting the mat board. The clamp is held between clamp hinges which include screws to exert a compressive force against the end of the clamp.

### BRIEF DESCRIPTION OF THE DRAWINGS

The invention may be more completely understood by considering the detailed description of various embodiments of the invention that follows in connection with the accompanying drawings.

FIG. 1 is a front perspective view of a mat board cutting device in accordance with the present invention.

FIG. 2 is a more detailed perspective view of the cutter head of the mat board cutting device of FIG. 1 with one of the side mounted blade carriers removed.

FIG. 3 is a rear view of a body of a blade carrier of FIG. 1 which can be mounted to the side of the cutter head of FIG. 2.

FIG. 4 is a front view of the blade carrier body of FIG. 3.

FIG. 5 is an end view of the insertion end of the blade carrier body of FIG. 3, taken parallel to the slot for receiving a blade holder.

FIG. 6 is a front perspective view of the blade holder for use with the blade carrier of FIG. 3.

FIG. 7 is an exploded front perspective view of the blade holder of FIG. 6.

FIG. 8 is a rear perspective view of the body of the blade holder of FIG. 6.

FIG. 9 is a first end view of the blade holder body of FIG. 8.

FIG. 10 is a second end view of the blade holder body of FIG. 8.

FIG. 11 is a first perspective view of a clamp hinge for use with the mat board cutting device of FIG. 1.

FIG. 12 is a second perspective view of the clamp hinge of FIG. 11.

FIG. 13 is a side view of a body of the clamp hinge of FIG. 11.

FIG. 14 is a cross-sectional view of the clamp hinge body taken along line 14-14 in FIG. 1, with the clamp shown in phantom lines for clarity.

FIG. 15 is a cross-sectional view of the clamp hinge body of FIG. 13, taken along line 15-15 in FIG. 14.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

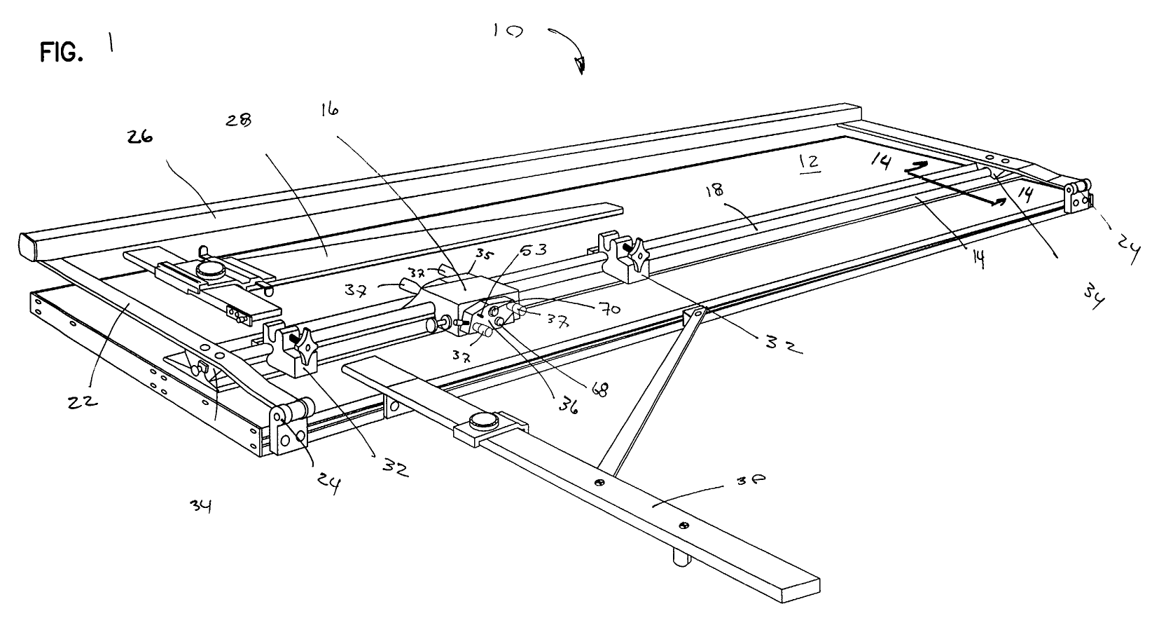

Machines such as a mat board cutting device 10 in FIG. 1 are used to prepare decorative mats for use in picture framing and similar decorative activities. Such machines aid in the making of consistent linear cuts in the relatively thick material comprising the mat boards. Due to the heavy material used for matting, cutting blades on such machines need to be held as rigidly supported as possible to make a clean cut line. The heavy material also dulls the cutting edges of such machines quickly and, since a sharp blade is most desirable for making clean cut lines, the cutting blade of such a machine should be simple to remove and replace.

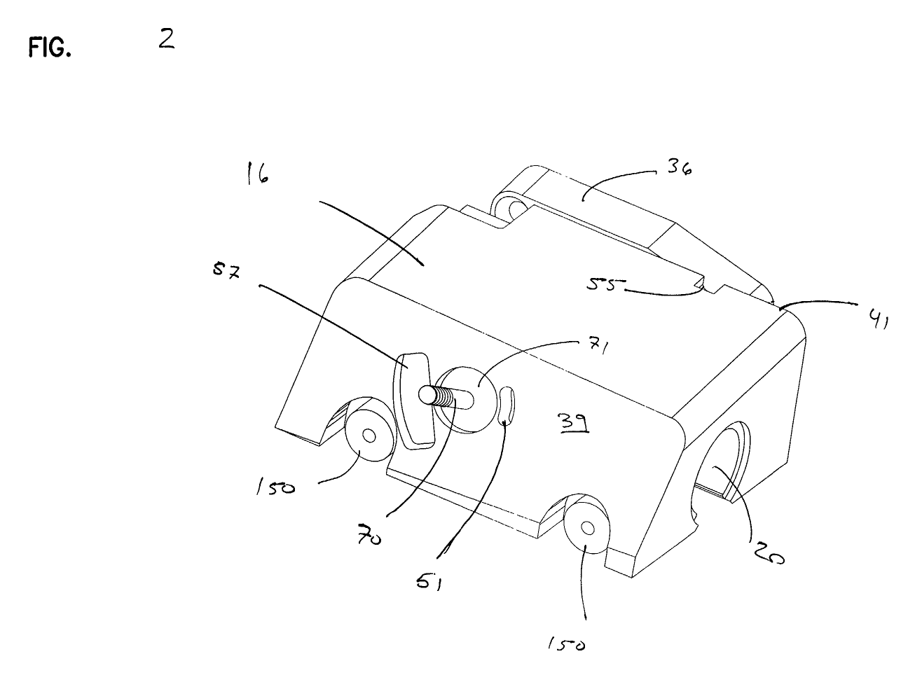

As shown in FIG. 1, mat board cutting device 10 such as contemplated by the present invention includes a cutting deck 12, a clamp 14 for securely holding mat boards to deck 12, and a cutter head 16 which is moved across clamp 14 and carries the blade holder described in more detail below. As shown, clamp 14 also includes an upper extension or rib 18, which is received within a guide slot 20 (see FIG. 2) in a bottom of cutter head 16 and guides the direction of movement of cutter head 16 across clamp 14. Clamp frame 22 is attached to one end of device 10 by hinges 24 and includes a clamp handle 26 for manipulation of clamp 14 by the user. Clamp frame 22 also includes a pair of clamp hinges 34 which connect clamp 14 to clamp frame 22 in a manner which will be described in further detail below. Mat guides 28 and 30 aid in the positioning of mat boards on deck 12 for cutting. A pair of stops 32 are mounted to rib 18 to limit the movement of cutter 16 and indicate the desired points to begin and end cutting of the mat board.

Preferably, clamp 14 is made of an aluminum extrusion which has not been pre-bend or shaped along its length. Other materials or combinations of material could be used to make clamp 14. Also, cutter head 16 is preferably made of aluminum but may be made of any sufficiently durable and rigid material capable of withstanding the pressures applied to cutter head 16 when using device 10 to cut mat boards.

Mounted to the sides of cutter head 16 are blade carriers 35 and 36. As shown in the FIGS., blade carriers 35 and 36 are mounted to each of two opposing sides of cutter head 16. Blade carriers 35 and 36 are pivotably mounted to cutter head 16 and each includes a blade for cutting mat boards. Pivoting blade carrier 35 or 36 allows the blade to selectively engage and cut the mat board as cutter head 16 is moved along clamp 14. Blade carriers 35 and 36 have substantially the same structure but are mounted at different angles on cutter head 16. Blade carrier 36 is mounted and pivots so that the blade engages the mat board substantially perpendicular to deck 12. Blade carrier 35 is mounted and pivots so that the blade engages the mat board at angle of approximately forty-one degrees with respect to the deck. Blade carrier 35 permits mat boards to be cut with angled edges for decorative purposes. It is anticipated that angles other than forty-one degrees may be desirable, such as forty-five degrees, thirty degrees or other angles, and a blade carrier may be mounted and pivot to engage the mat board at different angles.

Blade carriers 35 and 36 include a pair of handles 37 to permit a user to grasp and rotate blade carriers 35 and 36 to engage a mat board. A set screw 68 is provided to aid in the positioning of a cutting blade holder with blade carriers 35 and 36, as will be discussed in further detail below. Blade carriers 35 and 36 are mounted to cutter head 16 about a pair of pivots 70.

Referring now to FIG. 2, cutter head 16 is shown removed from device 10 with blade carrier 35 removed. Pivot 70 extends from mounting face 39 and includes a counter bore 71 for receiving bearings to aid in the rotation of blade carrier 35. An elongated recess 51 is provided to receive a motion limiter pin and cooperate with the pin to limit the extent of rotation of blade carrier 35 about pivot 70. A plurality of wheels 150 are mounted along a bottom surface of cutter head 16 and aid in the movement of cutter head 16 along clamp 14. A spring recess 57 is located on mounting face 39 to receive a return spring. An opposing side 41 of cutter head 16 to which blade carrier 36 is mounted is similarly configured. Opposing face 41 also includes a stop pin recess 55 for receiving a pivot stop pin mounted to blade carrier 36, as described below.

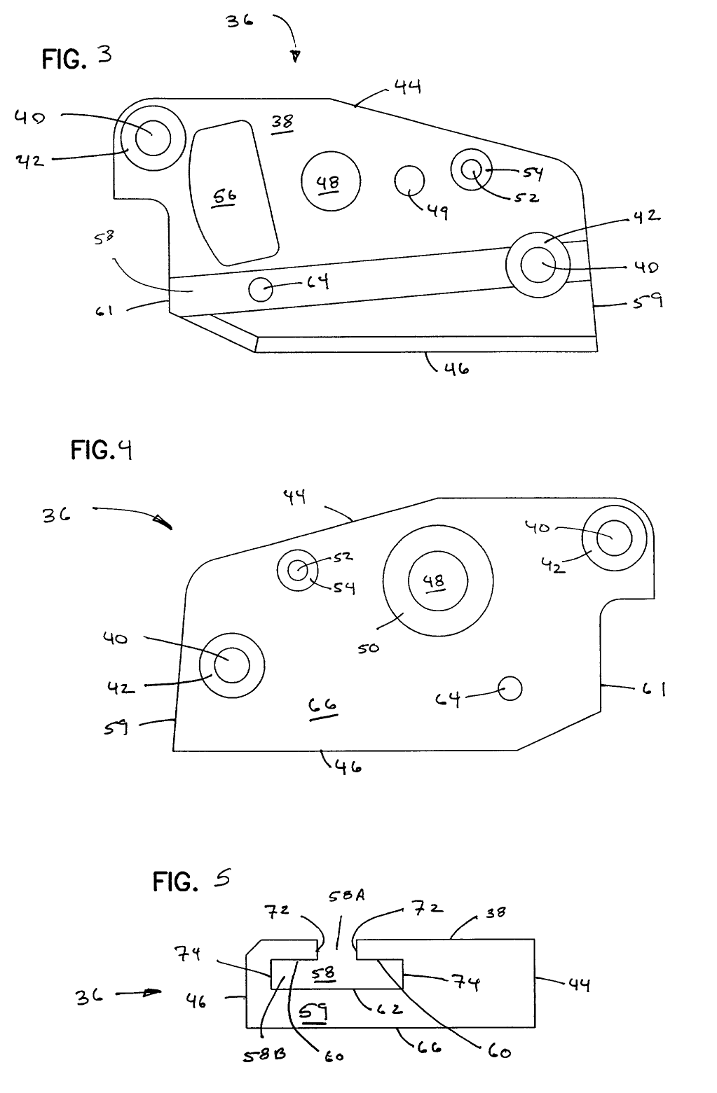

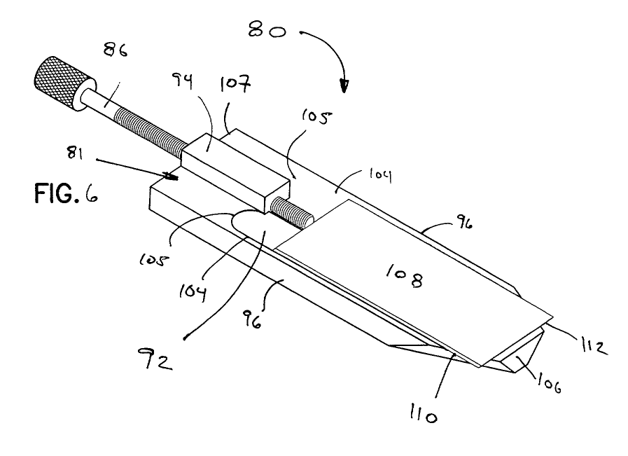

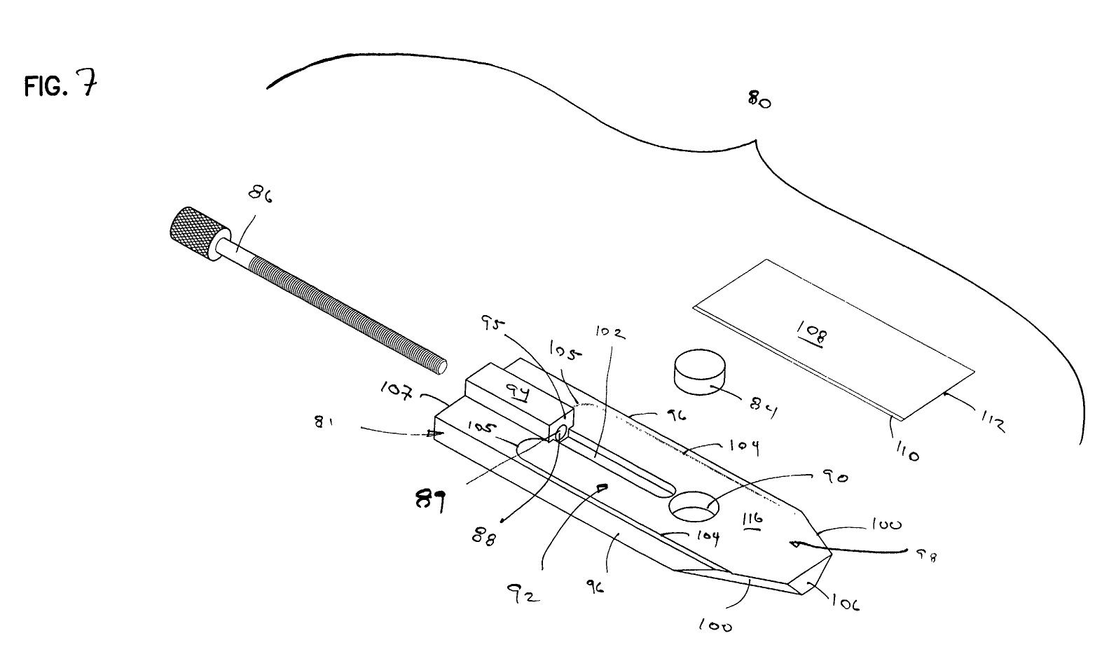

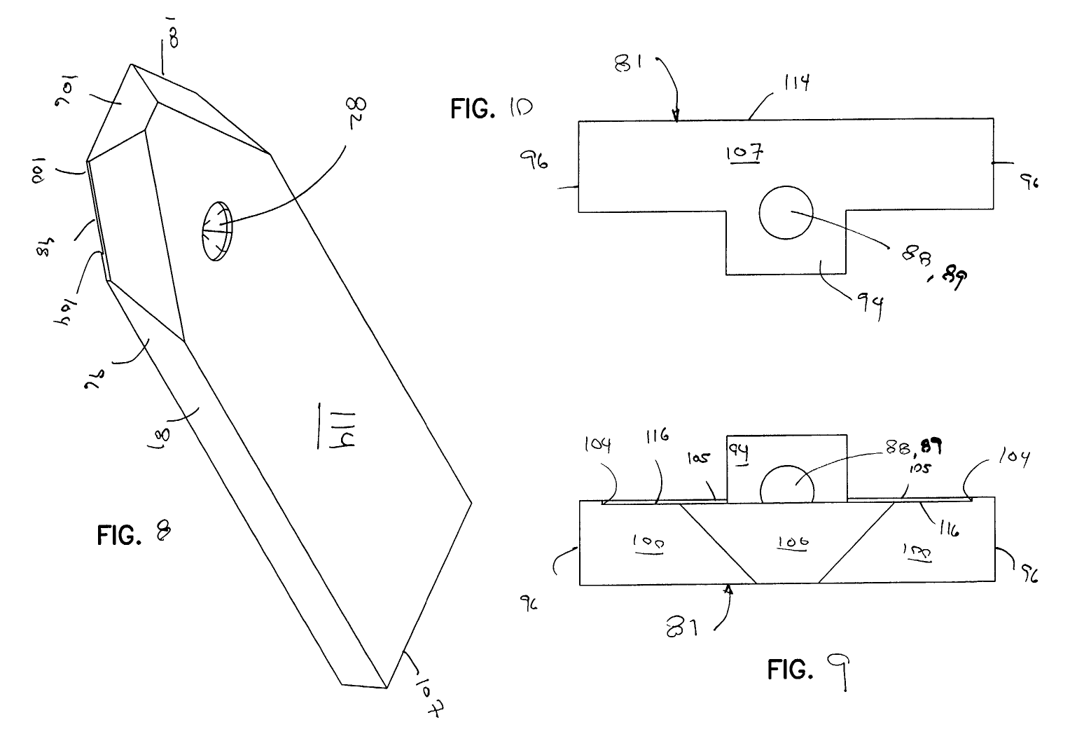

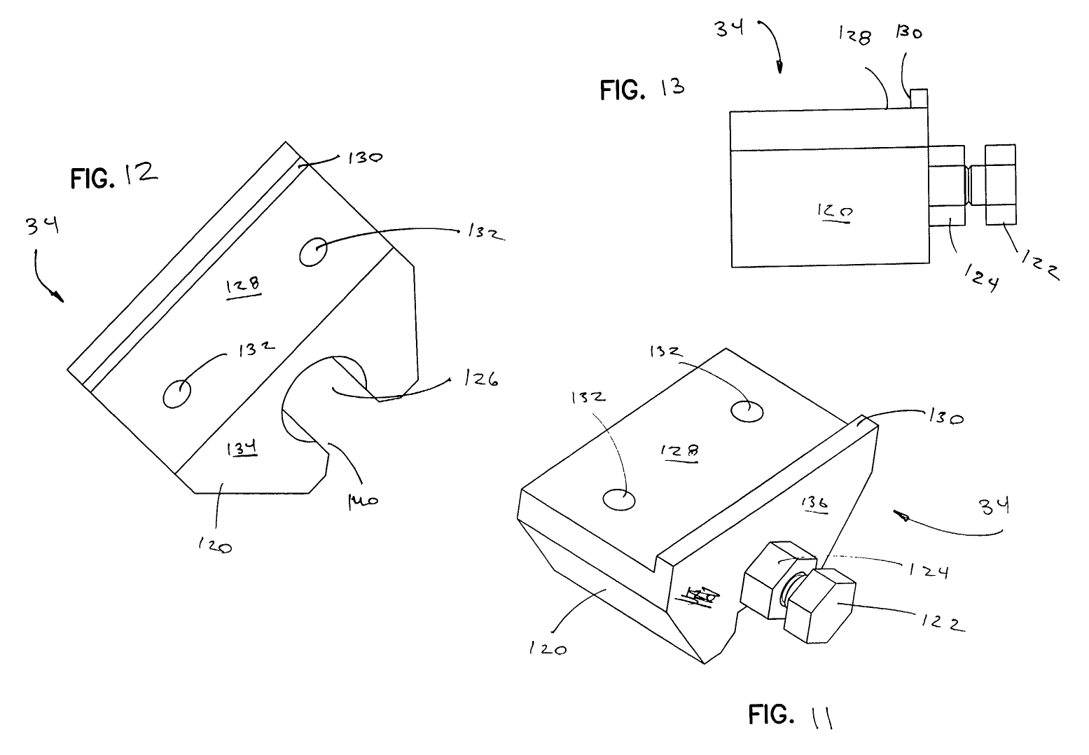

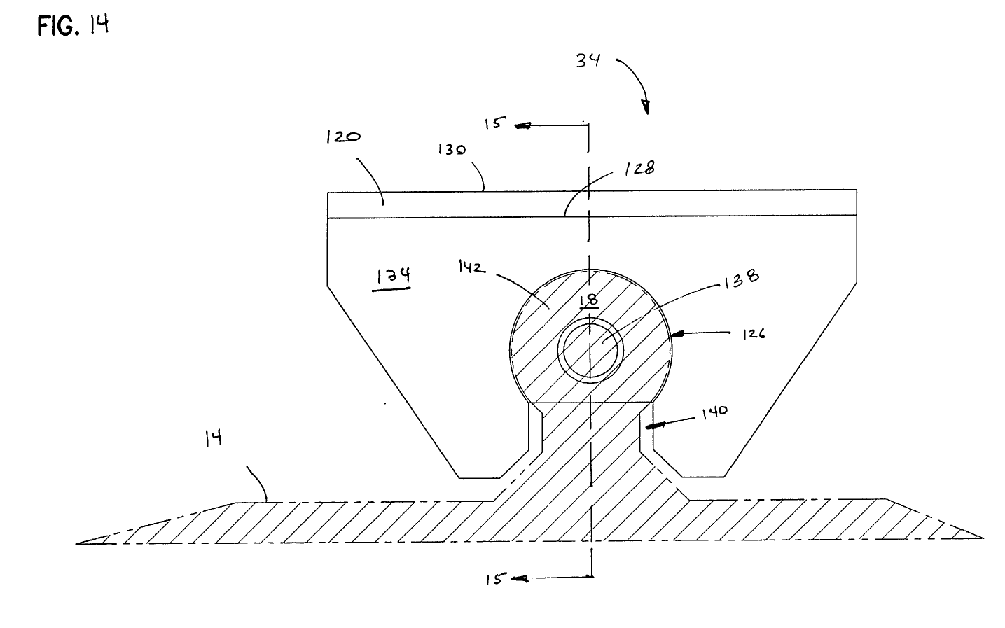

The structure of blade carriers 35 and 36 will now be described. For simplicity, blade carrier 36 will be referred to in this description. Referring now to FIGS. 3 through 5, a body 44 of blade carrier 36 is shown in further detail and includes an inner face 38 (FIG. 3) which is positioned toward cutter head 16 and an outer face 66 (FIG. 4) which is positioned away from cutter head 16 when blade carrier 36 is mounted to cutter head 16. A bottom edge 46 is toward deck 12 when blade carrier 36 is mounted to cutter head 16 and cutter head 16 is mounted to device 10. Handle openings 40 with counter bores 42 receive handles 37 (FIG. 1) to allow a user to pivot blade carrier 36 to engage the mat board. Counter bores 42 permit mounting of handles 37 in a manner which does not interfere with the pivoting of blade carrier 36 on cutter head 16.

Blade carrier 36 is mounted to cutter head 16 by pivot 70 extending from cutter head through a pivot opening 48 in blade carrier 36. A counter bore 50 about pivot opening 48 on outer face 66 permits the mounting of bearings about pivot 70 recessed below outer face 66 to improve the ease of pivoting without interfering with the ease of access to handles 37 for manipulation of blade carrier 36. A stop pin opening 52 with a counter bore 54 may be provided which allows for a pivot stop pin 53 (FIG. 1) to be mounted to blade carrier 36. Pivot stop pin 53 selectively engages a recess 55 in cutter head 16 (FIG. 2) to hold blade carrier 36 at a particular point of rotation so that the blade is engaging the mat board.

A set screw opening 64 on the blade carrier 36 is a threaded opening adapted to receive set screw 68. Set screw 68 selectively engages an indent 82 of a blade holder 80 (FIGS. 6 through 10, below) to position blade holder 80 within a slot 58. Additional detail of slot 58 and blade holder 80 is provided below. A spring recess 56 is formed on inner face 38 of blade carrier 36 which cooperates with spring recess 57 of cutter head 16 to house a return spring, which is biased to return blade carrier 36 to a position where the mat board is not engaged. A motion limiter pin opening 49, which is a blind bore and does not extend through body 44, is positioned to receive a motion limiter pin. The motion limiter pin extends into elongated opening 51 in cutter head 16 when blade carrier 36 is mounted cutter head 16 and serves to limit the extent of rotation of blade carrier 36 about pivot 70.

Blade carrier 36 is also preferably made of aluminum but may be made of any material sufficiently durable and rigid to withstand the force exerted on blade carrier 36 when device 10 is used to cut mat boards.

Referring now to FIGS. 6 through 10, blade holder 80, which is adapted to mount to the side of cutter head 16 perpendicular to deck 12, includes a body 81, a releasable blade holding means such as magnet 84 and a depth adjustment means such as screw 86. Screw 86 is received within a threaded opening 88 to a channel 89 extending through a raised portion 94 and screw 86 further extends into a groove 102 when advanced through channel 89. Blade holder body 81 is preferably made of steel and is a one-piece body. Other similar materials may also be used to make body 81. Alternatively, a softer material such as aluminum could be used for body 81. It may be desirable to treat such softer materials to provide a harder outer surface for durability. Body 81 may also be made from several individual parts and the material used to make each parts could be matched to the durability requirements for that part.

Magnet 84 is positioned within a magnet recess 90. In alternative embodiments, the magnet may be shaped differently, such as a rectangle, a square or other shape, and the magnet recess and magnet can be located at other positions on blade holder 80, such as adjacent open end 98 or rear wall 105.

A blade recess 92 is defined in body 81 by a pair of opposing walls 104 adjacent a pair of opposing sides 96 of body 81. Recess 92 also includes an open end 98 opposite opening 88. When a blade 108 is placed within recess 92, the extension of screw 86 through opening 88 will move blade 108 within recess 92 toward open end 98. Adjacent open end 98 is a first end or front end 106 of blade holder body 81 and a pair of beveled corners 100. Blade 108 extends within recess 92 substantially between walls 104 and includes at least one sharpened cutting edge 110. As screw 86 moves blade 108 to extend through open end 98, beveled corners 100 allow cutting edge 110 to be exposed before an end 112 of blade 108 extends beyond front end 106. This increases the support provided to blade 108 by blade holder 80 while allowing cutting edge 110 to engage the mat board to be cut. Blade 108 is preferably made of steel or a similar ferromagnetic material which magnet 84 attracts and holds within recess 92 and which is suitably durable for receiving and maintaining a sharp cutting edge 110.

A rear wall 105 to recess 92 is shown in the FIGS which has substantially the same height as walls 104 and is located opposite open end 98. Adjacent a second end 107, rear wall 105 is not necessary for the function of blade holder 80 as described herein, as a face 95 of raised portion 94 and/or screw 86 will serve to limit the insertion depth of blade 108 within recess 92. Alternatively, walls 104 may extend the entire length of holder body 81, so that no rear wall is formed. As a further alternative, recess 92 could taper smoothly to the height of walls 104 once recess 92 has extended beyond face 95. Recess 92 includes a floor 116 extending between walls 104 and between open end 98 and rear wall 105. In one embodiment, walls 104 extend above floor 116 by a distance which is equal to or slightly less than the thickness of blade 108. In another embodiment, walls 104 could be higher than the thickness of blade 108. This embodiment would include recesses formed within slot 58 to receive these higher walls 104, the recesses being deep enough to permit pressure from set screw 68 against indent 82 to press a side of blade 108 against an inner wall of slot 58, as described below.

Now referring to FIGS. 1 and 8, back side or rear surface 114 of body 81 includes indent 82 for receiving set screw 68. Indent 82 does not extend through body 81, so that as set screw 68 is advanced within opening 64, set screw 68 exerts pressure on body 81. Aligning set screw 68 and indent 82 can not be done directly, since blade holder 80 is within slot 58. External reference to determine the alignment of indent 82 and set screw 68 is provided by aligning second end 107 of blade holder 80 with an insertion end 59 of blade carrier 36. The distance from second end 107 to indent 82 of blade holder 80 is approximately equal to the distance from insertion end 59 to set screw 68 of blade carrier 36. The relationship between the length of blade holder 80 and blade carrier 36 may be altered and a different external reference provided to allow the user to align indent 82 with set screw 68. Examples of such an external reference include but are not limited to a line or other mark on holder body 81 which is aligned with insertion end 49 or a different reference point on blade carrier 36.

Now referring to FIGS. 5 and 7, blade holder 80 is placed within slot 58 through insertion end 59 of the blade carrier 36 so that raised portion 94 extends between a pair of opposing walls 72 of a narrow slot portion 58A and sides 96 extend between a pair of opposing walls 74 of a wider slot portion 58B. Blade holder 80 could also be inserted within slot 58 through opposite end 61 but this is less convenient when blade carrier 36 is mounted to device 10. So positioned, blade 108 and recess 92 are directed toward inner blade support faces 60 located adjacent to and substantially perpendicular to walls 72. Rear surface 114 of blade holder 80 (FIG. 8) is positioned adjacent rear wall 62. Indent 82 and set screw 68 cooperate to position blade holder 80 at a desired degree of insertion within slot 58 when second end 107 of blade holder 80 is aligned with insertion end 49 of blade carrier 36. Set screw 68 is preferably conically shaped at the end engaging indent 82, and indent 82 is preferably shaped in a complementary fashion. The cooperation of these shapes allows for appropriate engagement between set screw 68 and indent 82 despite any slight misalignment of insertion end 49 and second end 107 during insertion of blade holder 80 into blade carrier 36.

As set screw 68 is advanced into indent 82, blade 108 is urged against inner faces 60. Inner blade support faces 60 serve to provide additional support to blade 108 as blade 108 is used to cut mat boards on deck 12. Using a blade which is substantially the same thickness as the height of walls 104 ensures that blade 108 can receive support from both recess floor 116 and inner blade support faces 60. Use of thinner blades would allow the blade to move or float within slot 58, resulting in inconsistent cut lines in the mat board, or to even be pulled out of blade holder 80. In one embodiment, height of walls 104 is between 0.008 inches and 0.012 inches, preferably 0.010 inches, to accommodate use of blade 108 having a thickness of 0.010 and 0.020. It is anticipated that the most common blade thicknesses for use with blade holder 80 will be between 0.012 and 0.018 inches.

Blade holder 80 permits open access for placement and removal of blade 108 within recess 92. Open sided recess 92 also facilitates cleaning of blade holder 80 should any dust, paper shavings or other debris interfere with the movement or use of blade 108 to cut a mat board on deck 12.

Referring now to FIGS. 11 through 15, clamp hinge 34 is shown in greater detail. Clamp hinge 34 includes a clamp body 120, a compression screw 122 and a locking nut 124. Body 120 includes an inner face 134 through which is formed a closed ended channel or opening 126 for receiving rib 18 of clamp 14, as shown in FIG. 1. A neck extension 140 of opening 126 allows clamp 14 to extend from clamp hinge 34 when rib 18 is within opening 126. As shown in FIG. 14, channel 126 is sized to permit lateral and rotational movement of rib 18, that is, the dimensions of rib 18 are less than the dimensions of channel 126. Neck extension 140 is wider than the web portion 17 of clamp 14 extending to rib 18 and permit rotation of clamp 14 within clamp hinge 34 about rib 18. This allows clamp 14 to automatically adjust for mat boards of varying width and to lie flat upon whatever thickness material is placed on deck 12.

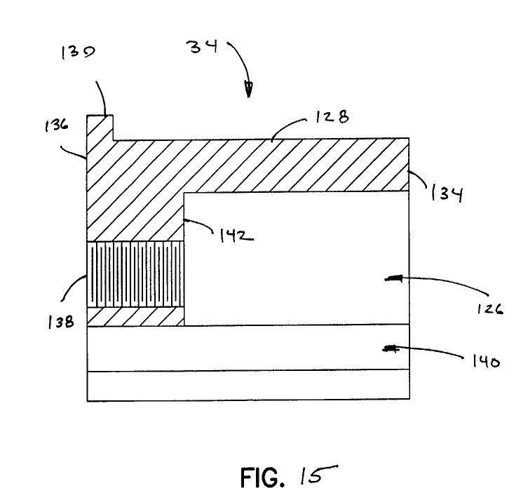

As shown in FIGS. 11 and 15, an end face 142 closes off channel 126. A threaded opening 138 extends through body 120 from an outer face 136 to end face 142 and receives screw 122. Body 120 also includes an upper surface 128 with a raised lip 130 and one or more fastener holes 132. Upper surface 128 fits against clamp frame 22 so that lip 130 rests against an outer edge of clamp frame 22. Fasteners such as screws 144 (shown in FIG. 1) extend through clamp frame 22 and are received within openings 132 to mount clamp hinge 34 to device 10. Clamp hinge 34 is preferably made of aluminum but may also be made of other similar materials, or may be made from a combination of materials without changing the function and use of clamp hinge 34 in accordance with the present invention.

Rib 18 includes substantially flat ends, meaning ends without holes or threaded openings, which are received within channels 126 when device 10 is assembled as shown in FIG. 1. Screw 122 within each clamp hinge 34 is engaged by the threads of opening 138 and threadably advanced until screw 122 engages the flat end of rib 18. Once screw 122 has engaged rib 18, further advancement of screw 122 will serve to compress rib 18 against end face 142 or screw 122 of the opposing clamp hinge 34. An alternative embodiment of hinge clamp 24 includes an insert of a relatively hard material such as steel between screw 122 and the ends of clamp 14. This insert will prevent screw 122 from scoring, gouging or otherwise damaging the end of clamp 14. Alternatively, ends of rib 18 may be include a shallow depression for receiving and centering screw 122 to ensure that screw 122 exerts compressive force along a desired line of rib 18.

Compression of rib 18 is desirable to improve the clamping force exerted by clamp 14 on the mat board being cut. When forcing clamp 14 against a mat board on deck 12, pressure is exerted by clamp frame 22 through clamp hinges 34 to the extreme ends of clamp 14. Unless the mat board extends underneath each end of clamp (which is impractical since the cutter head cannot typically travel to the ends of rib 18), clamp 14 will exert little or no pressure on the portion of the mat board located under the central portion of clamp 14. This eccentric loading of the clamp will tend to force clamp 14 to bow up in the center and potentially leave the mat board under the bowed portion unsupported. This may allow the mat board to slip or flex, resulting in a less than desirable cut line. Compression force applied to the ends of rib 18 by clamp hinges 34 will tend to counter act the tendency for the center of clamp 14 to bow upward when clamping pressure is applied to a mat board on deck 12. Further, clamp 14 and rib 18 may be made from a single piece extrusion. Such extrusions are not always flat which can also lead to uneven pressure being exerted on the mat board. Applying compression through clamp hinges 34 and bowing clamp 14 toward deck 12 will allow such a clamp 14 to apply more even force against the entire length of the mat board. By providing a means of compressing clamp 14 is this manner, the desirability of pre-bending clamp 14 into a bowed shape, which might provide similar results to the clamp of the present invention is reduced.

To replace a blade 108 in device 10, a user would release set screw 68 from indent 82, permitting blade holder 80 to be removed from slot 58. Once holder 80 is removed from slot 58, the user can remove blade 108 by applying enough pressure on blade 108 to break the attraction force of magnet 84 and removing blade 108 from recess 92. Recess 92 can then be cleaned of any debris that might have accumulated during cutting of mat boards. A new blade 108 can then be inserted within recess 92 trough the open side and held in place by magnet 84. Screw 86 can then be adjusted to set a desirable extension of blade 108 through open end 98. Blade holder 80 is then reinserted within slot 58 so that second end 107 of blade holder 80 and insertion end 59 of blade carrier 36 are aligned, indicating that indent 82 is aligned with set screw 68. Set screw 68 is tightened down, exerting pressure against holder body 81 to press blade 108 against inner faces 60.

Adjustment of the extension of blade 108 from blade holder 80 may be adjusted while blade holder 80 is within slot 58. The pressure exerted on blade 108 against inner faces 60 by body 81 must be eased by backing set screw 68 out. Set screw 68 need only be backed out enough to relieve the pressure but remain engaged in indent 82. The mount of extension of blade 108 can then be adjusted. To reduce the amount of extension, screw 86 is retracted and the user presses against the extended end of blade 108 to move blade 108 further into recess 92. To extend blade 108 further, screw 86 is advanced, urging blade 108 further out of recess 92. Adjustment of the blade depth may be desired to account for the thickness of the mat board or for wear or erosion of cutting edge 110.

The above specification and examples provide a complete description of the manufacture and use of the composition of the invention. Since many embodiments of the invention can be made without departing from the spirit and scope of the invention, the invention resides in the claims hereinafter appended.

What is claimed is:

1. A blade holder for a mat board cutting machine, the blade holder comprising:
a blade holder body comprising a first end and a second opposite end and defining a recessed blade area on a front side sized to receive a replaceable blade so that the blade may be positioned to extend off of the first end of the body, wherein the recessed area has a back surface and an open side opposite the back surface through which the blade may be received, wherein the recessed area is defined by the back surface, a first wall and an opposing second wall;
a mechanism for adjustably urging the blade away from second end of the body to adjust the extension of the blade off of the body at the first end; and
a magnet positioned in the back wall to removably hold the blade within the recessed area.

2. The blade holder of claim 1, wherein the blade holder body defines a recess within in the recessed area and the magnet is located in the recess.

3. The blade holder of claim 1, wherein the mechanism for urging the blade away from the second end is an adjusting screw that extends through the blade holder body into the recessed area.

4. The blade holder of claim 3, wherein the blade holder body further defines a passage for accommodating the adjusting screw at the second end and a groove for accommodating the adjusting screw in the recessed area adjacent to the passage.

5. The blade holder of claim 1, wherein the first end of the blade holder body includes a beveled corner along a first side of the body so that a cutting portion of the blade will extend outside recessed area while the blade is substantially within the recessed area.

6. The blade holder of claim 5, wherein the blade holder body includes a second beveled corner along a second side of the body, wherein the second side of the body is opposite the first side.

7. The blade holder of claim 1, wherein the blade holder body has a back side opposite the front side, wherein the back side of the blade holder body defines an indent for receiving an end of a tightening screw.

8. The blade holder of claim 1, further comprising a blade within the blade area wherein the blade comprises a ferromagnetic material.

9. The blade holder of claim 8, wherein the first and second walls having a height above the back surface substantially equal to or less than a thickness of the blade.

10. The blade holder of claim 1, wherein the blade holder body is a one piece body.

11. A cutter head for use with a mat board cutting device comprising:
(a) a cutter head body including a longitudinal opening adapted to receive and slidably mount the cutter head body to a clamp rib such that the cutter head body is moveable along a length of the clamp rib;
(b) a blade carrier pivotally mounted to a side of the cutter head body, wherein the blade carrier pivots about an axis which is perpendicular to the direction of movement of the cutter head body along the clamp rib, the blade carrier defining a slot; and
(c) a blade holder configured to be received in the slot, the blade holder comprising:
(i) a blade holder body comprising a first end and a second opposite end and defining a recessed blade area on a front side sized to receive a replaceable blade so that the blade may be positioned to extend off of the first end of the body, wherein the recessed area has a back surface and an open side opposite the back surface through which the blade may be received, wherein the recessed area is defined by the back surface, a first wall and an opposing second wall, and
(ii) a magnet positioned in the back wall to removably hold the blade within the recessed area.

12. The cutter head of claim 11, wherein the slot in the blade carrier for receiving the blade holder extends entirely through the blade carrier.

13. The cutter head of claim 11, the blade carrier further comprising a set screw which extends into the slot, wherein the blade holder body further comprises a back side opposite the front side, wherein the back side of the blade holder body defines an indent for receiving an end of the set screw, wherein the set screw is adapted to hold the blade holder at a first position.

14. The cutting head of claim 13, wherein a blade is mounted within the recessed area of the blade holder.

15. The cutting head of claim 14, wherein the set screw exerts pressure against the blade holder, urging the blade holder against an opposing interior wall of the slot and the blade holder presses the blade against the interior wall.

16. The cutting head of claim 14, wherein the blade holder further comprises a mechanism for adjustably urging the blade away from second end of the body to adjust the extension of the blade off of the body at the first end.

17. The cutter head of claim 16, wherein the mechanism for urging the blade away from the second end is an adjusting screw that extends through the blade holder body into the recessed area.

18. The cutting head of claim 17, wherein the blade holder body further defines a passage for accommodating the adjusting screw at the second end and a groove for accommodating the adjusting screw in the recessed area adjacent to the passage.

19. A mat board cutting machine comprising:
a deck;
a clamp extending along the length of the deck, the clamp comprising two ends;
a clamp frame mounted to the deck and supporting the clamp that is mounted to the frame by a pair of clamp hinges, each clamp hinge defining a channel for receiving one of the ends of the clamp, the channel comprising an open end and a closed end, wherein the clamp is received in the open end of the channel, the clamp hinge further comprising a screw extending through the closed end into the channel, the screw engaging and exerting pressure on the end of the clamp;
a cutter head slidably mounted to the clamp; and
a blade carrier pivotally mounted to the cutter head and adapted to receive and position a blade holder such that a blade held by the blade holder will engage and cut a mat board on the deck as the cutter head is moves along the clamp.

20. The mat board cutting machine of claim 19 wherein the clamp is pivotally mounted to the clamp frame by the clamp hinges.

21. The mat board cutting machine of claim 19, wherein the ends do not include an opening configured to receive and engage the screw.
